(19) United States
(12) Patent Application Publication
(10) Pub. No.: US 2007/0109915 A1
(43) Pub. Date: May 17, 2007

(54) Oil Change Reminder System

(76) Inventor: Neil Howell, Magnolia, TX (US)

Correspondence Address: TIM COOK, P.O. BOX 10107, LIBERTY, TX, 77575, US

(21) Appl. No.: 11/164,152

(22) Filed: Nov. 11, 2005

(51) Int. Cl. G04B 19/24

(52) U.S. Cl. 368/28

(57) ABSTRACT

A passive, manually operated counter conveniently displays a set of digits which define the mileage at which an oil change should be performed on a vehicle and a month display which defines the month of the next oil change.

### FIELD OF THE INVENTION

The present invention relates generally to the field of mechanical memory aids and, more particularly, to a manually operated system to remind a motorist when it is time for routine maintenance on the motorist's automobile, such as an oil change.

### BACKGROUND OF THE INVENTION

Routine maintenance procedures, such as oil changes, are required to be performed periodically on every motor vehicle. Failure to have oil changes performed on a motor vehicle on a regular basis shortens the lifetime of the vehicles engine because of the breakdown in the viscosity of the lubricating oil and the buildup of wear products.

Various means have been used in the past to remind vehicle owners and operators when such routine maintenance is due. Perhaps the most common means in use today to remind one that it's time to get an oil change on a vehicle is the use of a sticker which is filled out by an oil service mechanic and placed somewhere on the vehicle. The sticker typically includes a date and a mileage when the next oil change should be performed, whether the specified date or mileage occurs first. Usually, the sticker is applied to the door well of the vehicle or on the inside surface of the windshield in a location which will not obscure the vision of the driver of the vehicle.

Unfortunately, the next time that maintenance is performed on the vehicle, the sticker must be scraped off, often causing damage to the vehicle, or at least leaving a residue of adhesive behind. A new sticker is then applied, with the updated date and mileage for the next oil change.

Another system commonly in use today to remind vehicle owners and operators that it is time to get the oil changed in the vehicle is a computer based reminder system. Some such systems are quite elaborate, such as that described in U.S. Pat. No. 6,711,474. Others are simpler, yet still computer based. In certain of these simpler systems, an oil change reminder light and audible alarm are activated with a predetermined mileage has been counted up on the vehicles electronic odometer. Such systems, however, fail to take into account a predetermined date by which an oil change should be performed on the vehicle, relying solely on accumulated mileage since the last routine maintenance. In either case, such systems are unreasonably expensive and complex. Many owners either disable such systems, or they must refer to an owner's manual every time the alarm is activated in order to reset the alarm.

Thus, there remains a need for a simple, user friendly system to provide a vehicle owner or operator of the time and mileage at which an oil change is called for on a vehicle. The present invention is directed to solving this need in the art.

### SUMMARY OF THE INVENTION

The present invention addresses these and other needs in the art by providing a manually operated counter which conveniently displays a set of digits which define the mileage at which an oil change should be performed on a vehicle and a month display which defines the month of the next oil change.

The mileage digits are manually set by rotating a set of wheels, each wheel associated with a window, and each wheel having the digits 0-9 displayed thereon. The month wheel is similarly mounted behind a window, so that only one of the twelve months of the year is displayed through the month window at any one time.

The wheels for the mileage digits and the month are preferably held for rotational movement between a pair of plates. The front plate includes the windows the mileage digits and the month, while the back plate preferably includes an adhesive to secure the system of this invention in a convenient location, easily visible, within a vehicle.

These and other features and advantages of the present invention will be readily apparent to those of skill in the art from a review of the following detailed description along with the accompanying drawing figures.

### BRIEF DESCRIPTION OF THE DRAWINGS

FIG. 1 is a perspective view of the mileage/date reminder system of the present invention.

FIG. 2 is a front view in partial cutaway illustrating a mileage digit wheel of this invention.

FIG. 3 is a detail view of a dashboard of a motor vehicle with the mileage/date reminder system of this invention mounted thereon, as an example of an environment in which the present invention may find application.

### DETAILED DESCRIPTION OF A PREFERRED EMBODIMENT

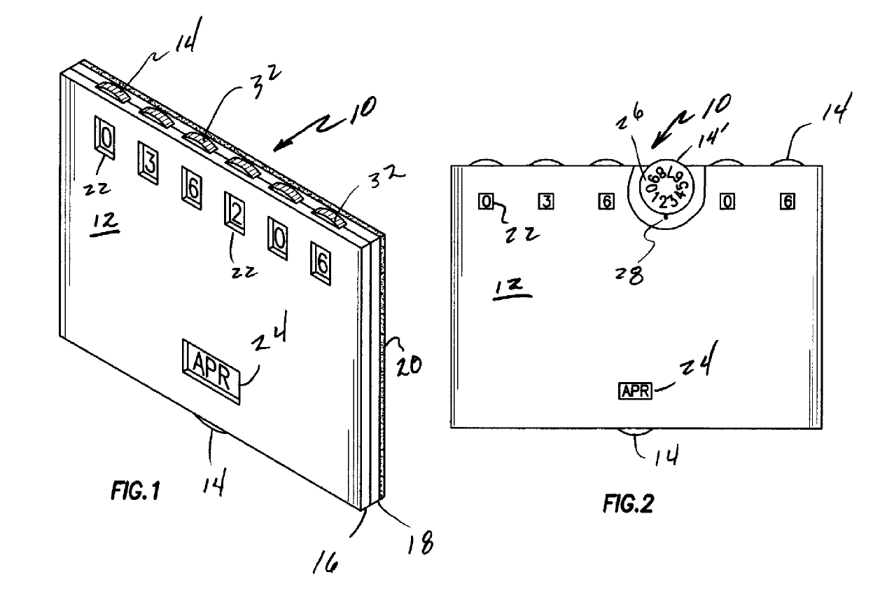

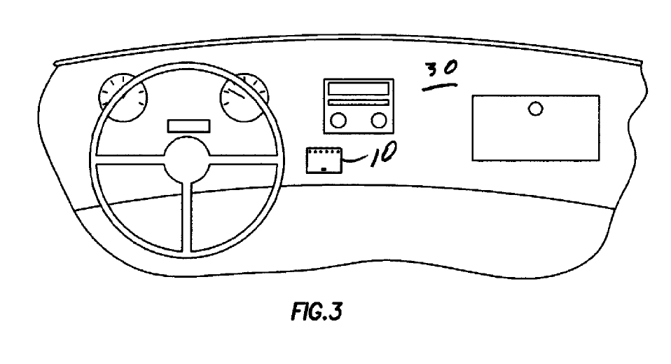

FIGS. 1 and 2 together depicts a presently preferred embodiment of a system 10 which reminds a motorist when it is time to have routine maintenance performed on a vehicle. The system 10 primarily comprises a body 12 and a plurality of wheels 14 retained by the body. The body 12 is preferably formed of a front plate 16 and a back plate 18, although a single element may be employed to retain the plurality of wheels 14. Further, an adhesive backing 20 is preferably applied to the back plate 18 to mount the system 10 to a convenient location within a vehicle, although other mounting means may be used within the scope and spirit of this invention.

The front plate 12 is preferably formed of an opaque material, such as for example an opaque impact resistance plastic. The front plate 12 defines a plurality of mileage digit windows 22, for example along an upper region of the front plate 12 as shown in FIGS. 1 and 2. Preferably, six such windows 22 are provided. Thus, the wheels 14 positioned behind the windows 22 are digit wheels and provide a user defined set of digits which are to be interpreted as a mileage setting. For example, if the user wishes to be reminded of the need for the vehicle's next oil change at a 3,000 mile interval from the last oil change, the digits are set to this mileage. A different interval may thus be used at the discretion of the user.

As shown in FIG.2, a specific digit wheel 14′ is used as an example of all of the digit wheels. The digits 0-9 are arrayed in order around a perimeter face 26 of the wheel 14′, so that only a single digit is positioned adjacent the associated window to display only that digit to the user. The back plate preferably provides a detent 28 for each wheel so that each digit wheel and its associated digit clicks into place until moved by the user. Each wheel 14 includes a knurled edge 32 providing friction for turning the wheels for the convenience of the user.

The front plate 12 also defines a date or month window 24. The wheel positioned behind the window 14 defines a month, set by the user, at which routine maintenance should be performed on the vehicle, such as for example three months from the last such maintenance. So, if the vehicle receives an oil change in January, the next oil change may be scheduled for April, as shown in the drawing figures.

Finally, FIG. 3 illustrates that the mileage/date reminder system 10 of this invention may be mounted, for example, on a dashboard 30 of a motor vehicle. It will be immediately recognized, however, that the system 10 is preferably sized to be mounted on the inside of the windshield, if desired, or inside the door well, so that it is easily visible whenever the vehicle operator enters or exits the vehicle.

It should be noted that this invention is totally passive. As used herein, the term “passive” refers to the fact that no electrical power is used. Furthermore, this system may be used over and over, including an extended period of time, for multiple maintenance events, unlike the ubiquitous stickers which must be replaced after each trip to the oil change garage. The invention would also serve as a visual reminder to the individual who changes his or her own oil, even if he or she does not use an oil change service.

The face of the front plate 12 may also be used to display a logo or the name of an oil change garage chain, in order to keep the name of the garage chain in mind of the consumer. The garage chain may thus provide the system 10 free of charge to their customers as a form of advertising for the garage chain, and as a convenience to its customers. Such use of the present invention also serves to maintain, or even enhance, customer loyalty.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

What is claimed is:

1. A passive mileage/date reminder system comprising:
a front plate defining a plurality of mileage digit windows and a date window therethrough;
a plurality of digit wheels, one digit wheel behind each of the plurality of mileage digit windows; and
a month wheel behind the date window.

2. The system of claim 1, further comprising a back plate behind the front plate and behind the digit wheel and the month wheel.

3. The system of claim 2, further comprising an adhesive backing behind the back plate.

4. The system of claim 2, further comprising a detent on the back wheel associated with each of the plurality of digit wheels.

5. The system of claim 2, further comprising a detect on the back wheel associated with the month wheel.

6. The system of claim 1, further comprising a knurled edge on each of the plurality of digit wheels and the months wheel.
